(19) United States
(12) Patent Application Publication
(10) Pub. No.: US 2025/0147187 A1
(43) Pub. Date: May 8, 2025

(54) DETERMINING VERTICAL CLEARANCE FOR A VEHICLE

(71) Applicant: GM Global Technology Operations LLC, Detroit, MI (US)

(72) Inventors: Azeem Sarwar, Rochester Hills, MI (US); Md Mhafuzul Islam, Warren, MI (US)

(21) Appl. No.: 18/502,653

(22) Filed: Nov. 6, 2023

(51) Int. Cl. G01S 17/931; G01B 11/06; G01S 7/481; G01V 8/10

(52) U.S. Cl. CPC G01S 17/931; G01B 11/0608; G01S 7/4817; G01V 8/10

(57) ABSTRACT

A system for determining vertical clearance for a vehicle may include a first ranging sensor operable to measure a distance relative to an object surrounding the vehicle. The system further may include a display operable to provide information to an occupant of the vehicle. The system further may include a controller in electrical communication with the first ranging sensor and the display. The controller is programmed to determine a minimum required vertical clearance based at least in part on a height of the vehicle. The controller is further programmed to determine a maximum available vertical clearance using the first ranging sensor. The controller is further programmed to provide a warning to the occupant of the vehicle using the display in response to determining that the maximum available vertical clearance is less than or equal to the minimum required vertical clearance.

### INTRODUCTION

The present disclosure relates to systems and methods for increasing occupant awareness for a vehicle, and more particularly, to systems and methods for determining vertical clearance for a vehicle.

To increase occupant comfort, convenience, and awareness, vehicles may be equipped with Advanced Driver Assistance Systems (ADAS) which are designed to assist the occupant in operating the vehicle. ADAS systems may use various sensors such as cameras, radar, ultrasound, and LiDAR to detect and identify objects around the vehicle, including other vehicles, pedestrians, and traffic signs. When a potential collision or obstacle is detected, the ADAS system may issue an alert to the occupant or take corrective action to prevent or mitigate the collision. Furthermore, vehicles may be equipped with parking sensors to assist the occupant in maneuvering the vehicle while parking, especially in confined spaces. Parking sensors may include, for example, ultrasonic ranging sensors. However, current ADAS systems and parking sensors may not account for vehicle height when maneuvering in low-clearance environments and/or with additional cargo and/or accessories affixed to a roof of the vehicle.

Thus, while current ADAS and parking sensor systems and methods achieve their intended purpose, there is a need for a new and improved system and method for determining vertical clearance for a vehicle.

### SUMMARY

According to several aspects, a system for determining vertical clearance for a vehicle is provided. The system may include a first ranging sensor operable to measure a distance relative to an object surrounding the vehicle. The system further may include a display operable to provide information to an occupant of the vehicle. The system further may include a controller in electrical communication with the first ranging sensor and the display. The controller is programmed to determine a minimum required vertical clearance based at least in part on a height of the vehicle. The controller is further programmed to determine a maximum available vertical clearance using the first ranging sensor. The controller is further programmed to provide a warning to the occupant of the vehicle using the display in response to determining that the maximum available vertical clearance is less than or equal to the minimum required vertical clearance.

In another aspect of the present disclosure, the display is further configured to receive input from the occupant of the vehicle. To determine the minimum required vertical clearance based at least in part on the height of the vehicle, the controller is further programmed to receive the height of the vehicle from the occupant of the vehicle using the display. To determine the minimum required vertical clearance based at least in part on the height of the vehicle, the controller is further programmed to determine the minimum required vertical clearance based at least in part on the height of the vehicle.

In another aspect of the present disclosure, the system includes at least one vertical height sensor in electrical communication with the controller. To determine the minimum required vertical clearance based at least in part on the height of the vehicle, the controller is further programmed to perform at least one vertical height measurement using the at least one vertical height sensor. The at least one vertical height measurement is a distance between a roof of the vehicle and a ground surface. To determine the minimum required vertical clearance based at least in part on the height of the vehicle, the controller is further programmed to determine the minimum required vertical clearance based at least in part on the at least one vertical height measurement.

In another aspect of the present disclosure, the at least one vertical height sensor further may include a first vertical height sensor, a second vertical height sensor, a third vertical height sensor, and a fourth vertical height sensor. To determine the minimum required vertical clearance, the controller is further programmed to perform a first vertical height measurement using the first vertical height sensor. The first vertical height measurement is a distance between a first corner of the roof of the vehicle and the ground surface. To determine the minimum required vertical clearance, the controller is further programmed to perform a second vertical height measurement using the second vertical height sensor. The second vertical height measurement is a distance between a second corner of the roof of the vehicle and the ground surface. To determine the minimum required vertical clearance, the controller is further programmed to perform a third vertical height measurement using the third vertical height sensor. The third vertical height measurement is a distance between a third corner of the roof of the vehicle and the ground surface. To determine the minimum required vertical clearance, the controller is further programmed to perform a fourth vertical height measurement using the fourth vertical height sensor. The fourth vertical height measurement is a distance between a fourth corner of the roof of the vehicle and the ground surface. To determine the minimum required vertical clearance, the controller is further programmed to determine the minimum required vertical clearance based at least in part on the first vertical height measurement, the second vertical height measurement, the third vertical height measurement, and the fourth vertical height measurement.

In another aspect of the present disclosure, the first ranging sensor further may include a range sensing element and an electric motor operable to rotate the range sensing element along a pitch axis. To determine the maximum available vertical clearance using the first ranging sensor, the controller is further programmed to measure a Euclidian distance between the first ranging sensor and the object surrounding the vehicle using the range sensing element. To determine the maximum available vertical clearance using the first ranging sensor, the controller is further programmed to determine a vertical clearance based at least in part on the Euclidian distance and a pitch angle of the range sensing element relative to the roof of the vehicle. To determine the maximum available vertical clearance using the first ranging sensor, the controller is further programmed to rotate the range sensing element using the electric motor to change the pitch angle of the range sensing element. To determine the maximum available vertical clearance using the first ranging sensor, the controller is further programmed to repeatedly measure the Euclidian distance, determine the vertical clearance, and rotate the range sensing element to determine a plurality of vertical clearances. To determine the maximum available vertical clearance using the first ranging sensor, the controller is further programmed to determine the maximum available vertical clearance to be a sum of a minimum value of the plurality of vertical clearances and a minimum value of the first vertical height measurement, the second vertical height measurement, the third vertical height measurement, and the fourth vertical height measurement.

In another aspect of the present disclosure, the first ranging sensor is further configured to measure a distance relative to an object in front of the vehicle. The system further includes a second ranging sensor in electrical communication with the controller. The second ranging sensor is configured to measure a distance relative to an object behind the vehicle.

In another aspect of the present disclosure, to determine the vertical clearance, the controller is further programmed to determine the vertical clearance using an equation:

$${c}_{v} = {d}_{e} * sin {θ}_{p}$$

where cᵥ is the vertical clearance, dₑ is the Euclidian distance, and θₚ is the pitch angle.

In another aspect of the present disclosure, to determine the minimum required vertical clearance, the controller is further programmed to determine the minimum required vertical clearance to be equal to a maximum value of the first vertical height measurement, the second vertical height measurement, the third vertical height measurement, and the fourth vertical height measurement.

In another aspect of the present disclosure, to determine the minimum required vertical clearance, the controller is further programmed to determine a height of a roof-mounted accessory affixed to the roof of the vehicle. To determine the minimum required vertical clearance, the controller is further programmed to determine the minimum required vertical clearance to be equal to a sum of the height of the roof-mounted accessory and a maximum value of the first vertical height measurement, the second vertical height measurement, the third vertical height measurement, and the fourth vertical height measurement.

In another aspect of the present disclosure, the system further includes a telescopic break-beam sensor system affixed to the roof of the vehicle including a first telescopic break-beam sensor and a second telescopic break-beam sensor in electrical communication with the controller. The telescopic break-beam sensor system is operable to detect an object occluding a line of sight between the first telescopic break-beam sensor and the second telescopic break-beam sensor. To determine the height of the roof-mounted accessory, the controller is further programmed to extend the first telescopic break-beam sensor and the second telescopic break-beam sensor until the line of sight between the first telescopic break-beam sensor and the second telescopic break-beam sensor is not occluded. To determine the height of the roof-mounted accessory, the controller is further programmed to retract the first telescopic break-beam sensor and the second telescopic break-beam sensor until the line of sight between the first telescopic break-beam sensor and the second telescopic break-beam sensor becomes occluded by the roof-mounted accessory. To determine the height of the roof-mounted accessory, the controller is further programmed to determine the height of the roof-mounted accessory to be equal to a height of the first telescopic break-beam sensor and the second telescopic break-beam sensor after retracting the first telescopic break-beam sensor and the second telescopic break-beam sensor until the line of sight between the first telescopic break-beam sensor and the second telescopic break-beam sensor becomes occluded by the roof-mounted accessory.

According to several aspects, a method for determining vertical clearance for a vehicle is provided. The method may include determining a minimum required vertical clearance based at least in part on a height of the vehicle. The method further may include determining a maximum available vertical clearance using a first ranging sensor. The method further may include providing a warning to an occupant of the vehicle using a display in response to determining that the maximum available vertical clearance is less than or equal to the minimum required vertical clearance.

In another aspect of the present disclosure, determining the minimum required vertical clearance further may include performing at least one vertical height measurement using at least one vertical height sensor. The at least one vertical height measurement is a distance between a roof of the vehicle and a ground surface. Determining the minimum required vertical clearance further may include determining the minimum required vertical clearance based at least in part on the at least one vertical height measurement.

In another aspect of the present disclosure, determining the minimum required vertical clearance further may include performing a first vertical height measurement using a first vertical height sensor. The first vertical height measurement is a distance between a first corner of the roof of the vehicle and the ground surface. Determining the minimum required vertical clearance further may include performing a second vertical height measurement using a second vertical height sensor. The second vertical height measurement is a distance between a second corner of the roof of the vehicle and the ground surface. Determining the minimum required vertical clearance further may include performing a third vertical height measurement using a third vertical height sensor. The third vertical height measurement is a distance between a third corner of the roof of the vehicle and the ground surface. Determining the minimum required vertical clearance further may include performing a fourth vertical height measurement using a fourth vertical height sensor. The fourth vertical height measurement is a distance between a fourth corner of the roof of the vehicle and the ground surface. Determining the minimum required vertical clearance further may include determining the minimum required vertical clearance based at least in part on the first vertical height measurement, the second vertical height measurement, the third vertical height measurement, and the fourth vertical height measurement.

In another aspect of the present disclosure, determining the maximum available vertical clearance using the first ranging sensor further may include measuring a Euclidian distance between the first ranging sensor and an object surrounding the vehicle using a range sensing element of the first ranging sensor. Determining the maximum available vertical clearance using the first ranging sensor further may include determining a vertical clearance based at least in part on the Euclidian distance and a pitch angle of the range sensing element relative to the roof of the vehicle. Determining the maximum available vertical clearance using the first ranging sensor further may include rotating the range sensing element to change the pitch angle of the range sensing element. Determining the maximum available vertical clearance using the first ranging sensor further may include repeatedly measuring the Euclidian distance, determining the vertical clearance, and rotating the range sensing element to determine a plurality of vertical clearances. Determining the maximum available vertical clearance using the first ranging sensor further may include determining the maximum available vertical clearance to be a sum of a minimum value of the plurality of vertical clearances and a minimum value of the first vertical height measurement, the second vertical height measurement, the third vertical height measurement, and the fourth vertical height measurement.

In another aspect of the present disclosure, determining the minimum required vertical clearance further may include determining the minimum required vertical clearance to be equal to a maximum value of the first vertical height measurement, the second vertical height measurement, the third vertical height measurement, and the fourth vertical height measurement.

In another aspect of the present disclosure, determining the minimum required vertical clearance further may include determining a height of a roof-mounted accessory affixed to the roof of the vehicle. Determining the minimum required vertical clearance further may include determining the minimum required vertical clearance to be equal to a sum of the height of the roof-mounted accessory and a maximum value of the first vertical height measurement, the second vertical height measurement, the third vertical height measurement, and the fourth vertical height measurement.

In another aspect of the present disclosure, determining the height of the roof-mounted accessory further may include extending a first telescopic break-beam sensor and a second telescopic break-beam sensor until a line of sight between the first telescopic break-beam sensor and the second telescopic break-beam sensor is not occluded. Determining the height of the roof-mounted accessory further may include retracting the first telescopic break-beam sensor and the second telescopic break-beam sensor until the line of sight between the first telescopic break-beam sensor and the second telescopic break-beam sensor becomes occluded by the roof-mounted accessory. Determining the height of the roof-mounted accessory further may include determining the height of the roof-mounted accessory to be equal to a height of the first telescopic break-beam sensor and the second telescopic break-beam sensor after retracting the first telescopic break-beam sensor and the second telescopic break-beam sensor until the line of sight between the first telescopic break-beam sensor and the second telescopic break-beam sensor becomes occluded by the roof-mounted accessory.

According to several aspects, a system for determining vertical clearance for a vehicle is provided. The system may include a first ranging sensor operable to measure a distance relative to an object in front of the vehicle. The first ranging sensor includes a range sensing element and an electric motor operable to rotate the range sensing element along a pitch axis. The system further may include at least one vertical height sensor. The system further may include a display operable to provide information to an occupant of the vehicle. The system further may include a controller in electrical communication with the first ranging sensor, the at least one vertical height sensor, and the display. The controller is programmed to perform at least one vertical height measurement using the at least one vertical height sensor. The at least one vertical height measurement is a distance between a roof of the vehicle and a ground surface. The controller is programmed to determine a minimum required vertical clearance based at least in part on the at least one vertical height measurement. The controller is programmed to determine a maximum available vertical clearance using the first ranging sensor. The controller is programmed to provide a warning to the occupant of the vehicle using the display in response to determining that the maximum available vertical clearance is less than or equal to the minimum required vertical clearance.

In another aspect of the present disclosure, to determine the minimum required vertical clearance, the controller is further programmed to perform a first vertical height measurement using a first vertical height sensor. The first vertical height measurement is a distance between a first corner of the roof of the vehicle and the ground surface. To determine the minimum required vertical clearance, the controller is further programmed to perform a second vertical height measurement using a second vertical height sensor. The second vertical height measurement is a distance between a second corner of the roof of the vehicle and the ground surface. To determine the minimum required vertical clearance, the controller is further programmed to perform a third vertical height measurement using a third vertical height sensor. The third vertical height measurement is a distance between a third corner of the roof of the vehicle and the ground surface. To determine the minimum required vertical clearance, the controller is further programmed to perform a fourth vertical height measurement using a fourth vertical height sensor. The fourth vertical height measurement is a distance between a fourth corner of the roof of the vehicle and the ground surface. To determine the minimum required vertical clearance, the controller is further programmed to determine the minimum required vertical clearance based at least in part on the first vertical height measurement, the second vertical height measurement, the third vertical height measurement, and the fourth vertical height measurement. The minimum required vertical clearance is a maximum value of the first vertical height measurement, the second vertical height measurement, the third vertical height measurement, and the fourth vertical height measurement.

In another aspect of the present disclosure, to determine the maximum available vertical clearance using the first ranging sensor, the controller is further programmed to measure a Euclidian distance between the first ranging sensor and the object surrounding the vehicle using the range sensing element. To determine the maximum available vertical clearance using the first ranging sensor, the controller is further programmed to determine a vertical clearance based at least in part on the Euclidian distance and a pitch angle of the first ranging sensor relative to the roof of the vehicle. To determine the maximum available vertical clearance using the first ranging sensor, the controller is further programmed to rotate the range sensing element using the electric motor to change the pitch angle of the range sensing element. To determine the maximum available vertical clearance using the first ranging sensor, the controller is further programmed to repeatedly measure the Euclidian distance, determine the vertical clearance, and rotate the range sensing element to determine a plurality of vertical clearances. To determine the maximum available vertical clearance using the first ranging sensor, the controller is further programmed to determine the maximum available vertical clearance to be a sum of a minimum value of the plurality of vertical clearances and a minimum value of the first vertical height measurement, the second vertical height measurement, the third vertical height measurement, and the fourth vertical height measurement.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for determining vertical clearance for a vehicle from a side view, according to an exemplary embodiment;

FIG. 2 is a schematic diagram of a system for determining vertical clearance for a vehicle from a top view, according to an exemplary embodiment; and

FIG. 3 is a flowchart of a method for determining vertical clearance for a vehicle, according to an exemplary embodiment.

### DETAILED DESCRIPTION

The following description is merely exemplary in nature and is not intended to limit the present disclosure, application, or uses.

In aspects of the present disclosure, occupants may desire to maneuver a vehicle in a space having low overhead clearance, including, for example, a parking garage, a tunnel, a bridge underpass, and/or the like. Furthermore, vehicles may be equipped with roof-mounted accessories and/or cargo, such as, for example, a roof-mounted cargo box, increasing the effective height of the vehicle. Current ADAS and parking assistance systems may not provide measurement or warning capabilities based on vehicle height. Therefore, the present disclosure provides a new and improved system and method for determining vertical clearance for a vehicle, allowing measurement of clearance in the environment, determination of vehicle height, and determination of additional vehicle height added by roof-mounted accessories and/or cargo.

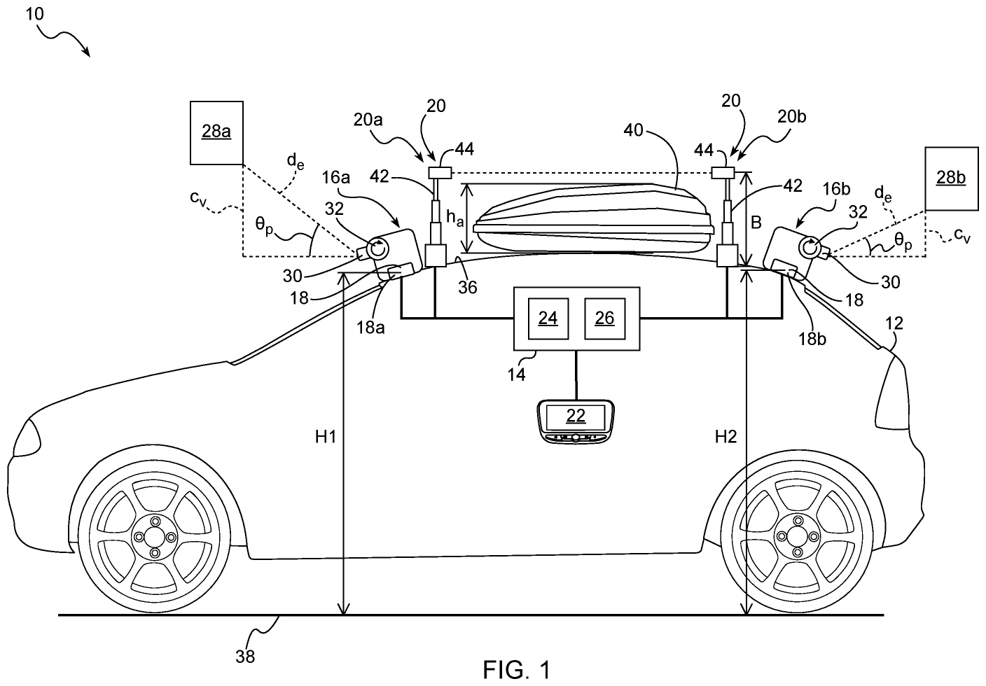

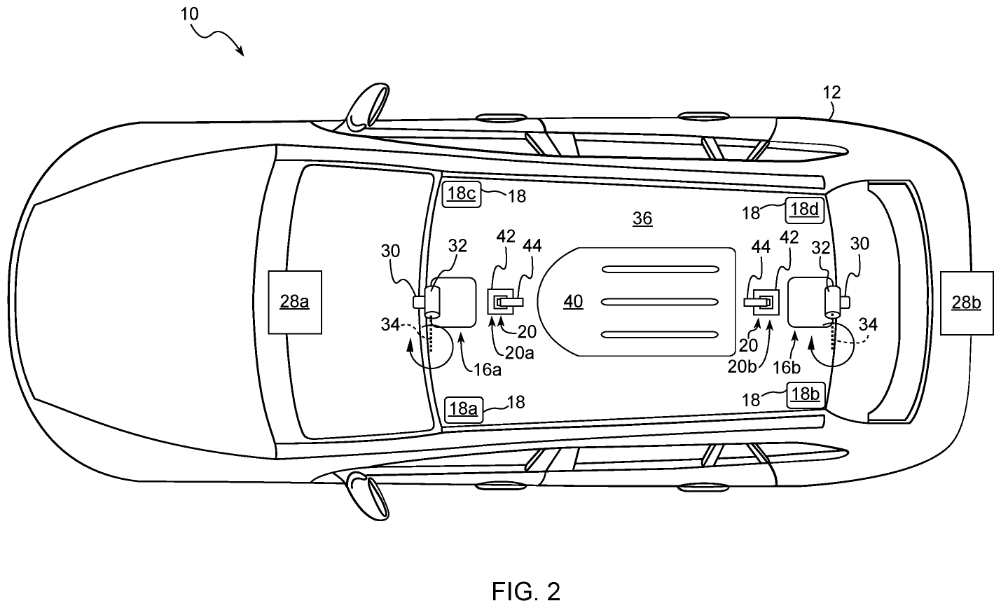

Referring to FIGS. 1 and 2, a system for determining vertical clearance for a vehicle is illustrated and generally indicated by reference number 10. The system 10 is shown with an exemplary vehicle 12. While a passenger vehicle is illustrated, it should be appreciated that the vehicle 12 may be any type of vehicle without departing from the scope of the present disclosure. FIG. 1 shows a schematic diagram of the system 10 from a side view of the vehicle 12. FIG. 2 shows a schematic diagram of the system 10 from a top-down view of the vehicle 12. The system 10 generally includes a controller 14, a first ranging sensor 16a, a second ranging sensor 16b, at least one vertical height sensor 18, a telescopic break-beam sensor system 20, and a display 22.

The controller 14 is used to implement a method 100 for determining vertical clearance for a vehicle, as will be described below. The controller 14 includes at least one processor 24 and a non-transitory computer readable storage device or media 26. The processor 24 may be a custom made or commercially available processor, a central processing unit (CPU), a graphics processing unit (GPU), an auxiliary processor among several processors associated with the controller 14, a semiconductor-based microprocessor (in the form of a microchip or chip set), a macroprocessor, a combination thereof, or generally a device for executing instructions. The computer readable storage device or media 26 may include volatile and nonvolatile storage in read-only memory (ROM), random-access memory (RAM), and keep-alive memory (KAM), for example. KAM is a persistent or nonvolatile memory that may be used to store various operating variables while the processor 24 is powered down. The computer-readable storage device or media 26 may be implemented using a number of memory devices such as PROMs (programmable read-only memory), EPROMS (electrically PROM), EEPROMs (electrically erasable PROM), flash memory, or another electric, magnetic, optical, or combination memory devices capable of storing data, some of which represent executable instructions, used by the controller 14 to control various systems of the vehicle 12. The controller 14 may also consist of multiple controllers which are in electrical communication with each other. The controller 14 may be inter-connected with additional systems and/or controllers of the vehicle 12, allowing the controller 14 to access data such as, for example, speed, acceleration, braking, and steering angle of the vehicle 12.

The controller 14 is in electrical communication with the first ranging sensor 16a, the second ranging sensor 16b, the at least one vertical height sensor 18, the telescopic break-beam sensor system 20, and the display 22. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the controller 14 are within the scope of the present disclosure.

The first ranging sensor 16a and the second ranging sensor 16b are used to measure distances relative to objects surrounding the vehicle 12. In an exemplary embodiment, the first ranging sensor 16a is configured to measure a distance relative to a first object 28a in front of the vehicle 12. The second ranging sensor 16b is configured to measure a distance relative to a second object 28b behind the vehicle 12. In a non-limiting example, the first ranging sensor 16a is used when the vehicle 12 is moving forward (e.g., toward the first object 28a). The second ranging sensor 16b is used when the vehicle 12 is moving backward (e.g., toward the second object 28b).

In the present disclosure, any disclosure made in reference to the first ranging sensor 16a is equally applicable to the second ranging sensor 16b. Any disclosure made in reference to the second ranging sensor 16b is equally applicable to the first ranging sensor 16a. It should be understood that all system components and methods discussed in reference to the first ranging sensor 16a and/or the second ranging sensor 16b are equally applicable to the second ranging sensor 16b and/or the first ranging sensor 16a. In an exemplary embodiment, the first ranging sensor 16a and the second ranging sensor 16b are structurally and functionally identical, differing principally in their location on the vehicle 12 and field-of-view relative to the vehicle 12. It should be understood that device-specific operational parameters, such as, for example, calibration parameters and/or the like may also differ between the first ranging sensor 16a and the second ranging sensor 16b.

The first ranging sensor 16a and the second ranging sensor 16b include a range sensing element 30 and an electric motor 32. The range sensing element 30 is used to measure a Euclidian distance dₑ between the range sensing element 30 and the first object 28a and/or the second object 28b. In an exemplary embodiment, the range sensing element 30 is a LiDAR (light detection and ranging) sensor. In an exemplary embodiment, the LiDAR sensor works by targeting objects in the environment with a laser and measuring a time required for reflected light from the laser to return to the LiDAR sensor. Use of alternative and/or additional ranging sensors, such as, for example, ultrasonic ranging sensors, radar sensors, time-of-flight sensors, and/or cameras is within the scope of the present disclosure. The range sensing element 30 is in electrical communication with the controller 14 as described above.

The electric motor 32 is used to rotate the range sensing element 30 along a pitch axis 34 (FIG. 2), allowing the range sensing element 30 to measure distances between multiple points in the environment. In an exemplary embodiment, the electric motor 32 is a brushed DC motor, a brushless DC motor, an AC motor, a stepper motor, a servo motor, and/or the like. The angle of the range sensing element 30 is defined as a pitch angle θₚ. In an exemplary embodiment, the electric motor 32 further includes a device configured to measure the pitch angle θₚ, including, for example, a rotary encoder, a magnetic angle sensor, and/or the like. In an exemplary embodiment, the electric motor 32 is capable of rotating the range sensing element 30 through a range of pitch angles defined as a pitch angle range. In a non-limiting example, the pitch angle range includes a minimum pitch angle of −45 degrees and a maximum pitch angle of 45 degrees. The electric motor 32 is in electrical communication with the controller 14 as described above.

In an exemplary embodiment, the first ranging sensor 16a and the second ranging sensor 16b are affixed to a roof 36 of the vehicle 12. In a non-limiting example, the first ranging sensor 16a is affixed proximally to a front of the roof 36 having a field-of-view in front of the vehicle 12. The second ranging sensor 16b is affixed proximally to a rear of the roof 36 having a field-of-view behind the vehicle 12. A distance between the roof 36 and a point on the first object 28a and/or the second object 28b is defined as a vertical clearance cᵥ. The vertical clearance cᵥ may be determined based on the Euclidian distance dₑ and the pitch angle θₚ, as will be discussed in greater detail below.

The at least one vertical height sensor 18 is used to determine a height of the vehicle 12. In an exemplary embodiment, the at least one vertical height sensor 18 includes a plurality of vertical height sensors 18. In an exemplary embodiment, the plurality of vertical height sensors 18 are configured to measure a distance relative to a ground surface 38. In an exemplary embodiment, a first vertical height sensor 18a measures a first vertical height measurement H1 (FIG. 1) between a first corner of the roof 36 and the ground surface 38. A second vertical height sensor 18b measures a second vertical height measurement H2 (FIG. 1) between a second corner of the roof 36 and the ground surface 38. A third vertical height sensor 18c (FIG. 2) measures a third vertical height measurement H3 (not shown) between a third corner of the roof 36 and the ground surface 38. A fourth vertical height sensor 18d (FIG. 2) measures a fourth vertical height measurement H4 (not shown) between a fourth corner of the roof 36 and the ground surface 38.

In an exemplary embodiment, the plurality of vertical height sensors 18 are LiDAR (light detection and ranging) sensors. In an exemplary embodiment, LiDAR sensors work by targeting the ground surface 38 with a laser and measuring a time required for reflected light from the laser to return to the LiDAR sensor. Use of alternative and/or additional ranging sensors, such as, for example, ultrasonic ranging sensors, radar sensors, time-of-flight sensors, and/or cameras is within the scope of the present disclosure. The vertical height sensors 18 are in electrical communication with the controller 14 as described above.

The telescopic break-beam sensor system 20 includes a first telescopic break-beam sensor 20a and a second telescopic break-beam sensor 20b. The first telescopic break-beam sensor 20a and the second telescopic break-beam sensor 20b are used to determine a height hₐ of a roof-mounted accessory 40. In the scope of the present disclosure, the roof-mounted accessory 40 is any additional equipment affixed to the roof 36 of the vehicle 12 to add utility, functionality, and/or aesthetic modification to the vehicle 12 (e.g., enhancing storage capacity, improving aerodynamics, increasing connectivity, and/or the like). The roof-mounted accessory 40 includes, for example, a roof rack, a cargo box, a roof basket, a roof-mounted storage bag, a roof tent, a bike rack, a roof-mounted solar panel, a roof-mounted antenna, and/or the like.

In an exemplary embodiment, the first telescopic break-beam sensor 20a and the second telescopic break-beam sensor 20b include a telescoping mount 42 and a break-beam element 44. The telescoping mount 42 is used to elevate the break-beam element 44 above the roof 36. The telescoping mount 42 is affixed at a first end to the roof 36 and at a second end to the break-beam element 44. In a non-limiting example, the telescoping mount 42 is removably affixed to the roof 36 using a magnetic mount. In an exemplary embodiment, the telescoping mount 42 includes a series of nested tubes of progressively smaller diameter. Using hydraulic and/or pneumatic actuation, the nested tubes are extended, causing the telescoping mount 42 to increase in length.

In another exemplary embodiment, the telescoping mount 42 includes one or more electromechanical linear actuators, including, for example, a leadscrew, a screw jack, a ball screw, a roller screw, a rack and pinion, and/or the like. In another exemplary embodiment, the telescoping mount 42 includes a compliant mechanism actuated hydraulically, pneumatically, and/or electrically. In an exemplary embodiment, the telescoping mount 42 further includes one or more sensors for measuring a height B of the break-beam elements 44 above the roof 36, including, for example, a linear encoder and/or the like. It should be understood that any mechanism for elevating the break-beam element 44 above the roof 36 is within the scope of the present disclosure. The telescoping mount 42 is in electrical communication with the controller 14 as described above.

The break-beam element 44 is used to detect occlusion of a line of sight between the first telescopic break-beam sensor 20a and the second telescopic break-beam sensor 20b. In an exemplary embodiment, the break-beam element 44 includes at least one of: a light transmitter and light sensor. The light transmitter is a light source configured to produce a focused beam of light. In a non-limiting example, the light transmitter is a laser, a light emitting diode (LED), and/or the like. The light sensor is a sensor configured to detect the focused beam of light produced by the light transmitter. In a non-limiting example, the light sensor includes a photodiode, a phototransistor, a photoresistor, and/or the like.

In an exemplary embodiment, the break-beam element 44 of the first telescopic break-beam sensor 20a is configured to transmit a light beam incident upon the light sensor of the break-beam element 44 of the second telescopic break-beam sensor 20b. The break-beam element 44 of the second telescopic break-beam sensor 20b is configured to provide an electrical signal to the controller 14 indicating whether or not the light beam is received by the light sensor. If the light beam is not received by the light sensor, the line of sight between the first telescopic break-beam sensor 20a and the second telescopic break-beam sensor 20b is considered to be occluded. It should be understood that either the first telescopic break-beam sensor 20a or the second telescopic break-beam sensor 20b may be used to transmit or receive the light beam without departing from the scope of the present disclosure.

As discussed above, the break-beam element 44 is extendable above the roof 36 using the telescoping mount 42. The telescoping mount 42 of the first telescopic break-beam sensor 20a and the second telescopic break-beam sensor 20b are extended and retracted in unison, such that the break-beam elements 44 of the first telescopic break-beam sensor 20a and the second telescopic break-beam sensor 20b are aligned. The break-beam element 44 is in electrical communication with the controller 14 as described above.

The first telescopic break-beam sensor 20a and the second telescopic break-beam sensor 20b are aligned such that the line of sight between the first telescopic break-beam sensor 20a and the second telescopic break-beam sensor 20b is occluded when the height B of the break-beam elements 44 above the roof 36 is less than or equal to the height hₐ of the roof-mounted accessory 40. Therefore, the height hₐ of the roof-mounted accessory 40 may be determined using the first telescopic break-beam sensor 20a and the second telescopic break-beam sensor 20b, as will be discussed in greater detail below.

While two telescopic break-beam sensors (i.e., the first telescopic break-beam sensor 20a and the second telescopic break-beam sensor 20b) are shown in FIGS. 1 and 2, it should be understood that the system 10 may include additional telescopic break-beam sensors without departing from the scope of the present disclosure. In a non-limiting example, the additional telescopic break-beam sensors are located such that they may be used to measure a height of cargo carried in a utility vehicle, such as, for example around a perimeter of a cargo bed of a pick-up truck. In another non-limiting example, the additional telescopic break-beam sensors are located to provide complete coverage of the vehicle 12, allowing for measurement of any objects protruding above the roof 36 of the vehicle 12.

The display 22 is used to provide information (e.g., a warning) to an occupant of the vehicle 12. In the scope of the present disclosure, the occupant includes a driver and/or a passenger of the vehicle 12. In the exemplary embodiment depicted in FIG. 1, the display 22 is a human-machine interface (HMI) located in view of the occupant and capable of displaying text, graphics and/or images. It is to be understood that HMI display systems including LCD displays, LED displays, and the like are within the scope of the present disclosure. Further exemplary embodiments where the display 22 is disposed in a rearview mirror are also within the scope of the present disclosure. In another exemplary embodiment, the display 22 includes a head-up display (HUD) configured to provide information to the occupant by projecting text, graphics, and/or images upon the windscreen of the vehicle 12. The text, graphics, and/or images are reflected by the windscreen of the vehicle 12 and are visible to the occupant without looking away from a roadway ahead of the vehicle 12. In another exemplary embodiment, the display 22 includes an augmented reality head-up display (AR-HUD). The AR-HUD is a type of HUD configured to augment the occupant's vision of the roadway ahead of the vehicle 12 by overlaying text, graphics, and/or images on physical objects in the environment surrounding the vehicle 12 within a field-of-view of the occupant. In an exemplary embodiment, the occupant may interact with the display 22 using a human-interface device (HID), including, for example, a touchscreen, an electromechanical switch, a capacitive switch, a rotary knob, and the like. It should be understood that additional systems for displaying information to the occupant of the vehicle 12 are also within the scope of the present disclosure. The display 22 is in electrical communication with the controller 14 as described above.

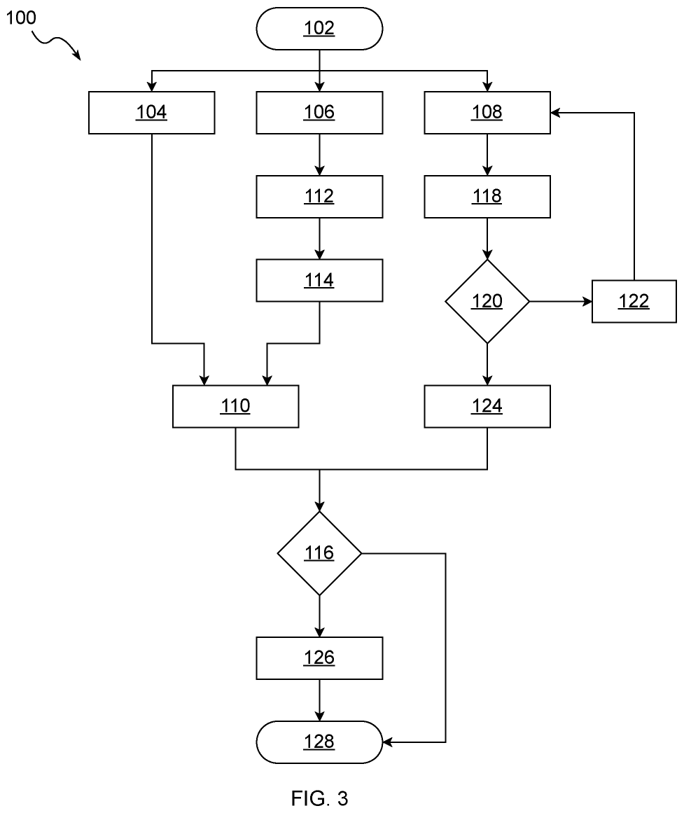

Referring to FIG. 3, a flowchart of the method 100 for determining vertical clearance for a vehicle is shown. The method 100 begins at block 102 and proceeds to blocks 104, 106, and 108. At block 104, the controller 14 determines a height of the vehicle 12. In an exemplary embodiment, to determine the height of the vehicle 12, the controller 14 uses the display 22. In a non-limiting example, the controller 14 prompts the occupant of the vehicle 12 to provide the height of the vehicle 12. The occupant then interacts with the display 22 using a human-interface device (HID), including, for example, a touchscreen, an electromechanical switch, a capacitive switch, a rotary knob, a voice-recognition system, and/or the like to provide the height of the vehicle.

In another exemplary embodiment, the controller 14 uses the plurality of vertical height sensors 18 to determine the height of the vehicle 12. In a non-limiting example, the controller 14 performs the first vertical height measurement H1 using the first vertical height sensor 18a, the second vertical height measurement H2 using the second vertical height sensor 18b, the third vertical height measurement H3 using the third vertical height sensor 18c, and the fourth vertical height measurement H4 using the fourth vertical height sensor 18d, as discussed above. The height of the vehicle 12 is determined to be a maximum value of H1, H2, H3, and H4:

$${h}_{v} = max ( H 1 , H 2 , H 3 , H 4 ) \qquad ( 1 )$$

wherein hᵥ is the height of the vehicle 12. After block 104, the method 100 proceeds to block 110, as will be discussed in greater detail below.

At block 106, the controller 14 extends the first telescopic break-beam sensor 20a and the second telescopic break-beam sensor 20b. In a non-limiting example, the first telescopic break-beam sensor 20a and the second telescopic break-beam sensor 20b are extended by actuating the telescoping mount 42 as discussed above. In an exemplary embodiment, the first telescopic break-beam sensor 20a and the second telescopic break-beam sensor 20b are extended at least until the line of sight between the first telescopic break-beam sensor 20a and the second telescopic break-beam sensor 20b is not occluded by the roof-mounted accessory 40. In a non-limiting example, the line of sight is detected using the break-beam element 44, as discussed above. After block 106, the method 100 proceeds to block 112.

At block 112, the controller 14 retracts the first telescopic break-beam sensor 20a and the second telescopic break-beam sensor 20b until the line of sight is occluded by the roof-mounted accessory 40. In a non-limiting example, the first telescopic break-beam sensor 20a and the second telescopic break-beam sensor 20b are retracted by actuating the telescoping mount 42 as discussed above. In a non-limiting example, the line of sight is detected using the break-beam element 44, as discussed above. After block 112, the method 100 proceeds to block 114.

At block 114, the controller 14 determines the height of the roof-mounted accessory 40. In an exemplary embodiment, the height of the roof-mounted accessory 40 is determined to be equal to the height B of the break-beam elements 44 above the roof 36 after completion of block 112. In another exemplary embodiment, the controller 14 prompts the occupant of the vehicle 12 to provide the height of the roof-mounted accessory 40. The occupant then interacts with the display 22 using a human-interface device (HID), including, for example, a touchscreen, an electromechanical switch, a capacitive switch, a rotary knob, a voice-recognition system, and/or the like to provide the height of the roof-mounted accessory 40. After block 114, the method 100 proceeds to block 110.

At block 110, the controller 14 determines a minimum required vertical clearance for the vehicle 12. In an exemplary embodiment, the minimum required vertical clearance is defined by an equation:

$${v}_{req , min} = {h}_{a} + {h}_{v} \qquad ( 2 )$$

wherein v_{req,min} is the minimum required vertical clearance, hₐ is the height of the roof-mounted accessory 40 determined at block 114, and hᵥ is the height of the vehicle as determined at block 104 and defined in Equation 1 above. After block 110, the method 100 proceeds to block 116, as will be discussed in greater detail below.

At block 108, the controller 14 measures the Euclidian distance dₑ between the range sensing element 30 and the first object 28a and/or the second object 28b using the first ranging sensor 16a and/or the second ranging sensor 16b, as discussed above. After block 108, the method 100 proceeds to block 118.

At block 118, the controller 14 determines the vertical clearance cᵥ based at least in part on the Euclidian distance dₑ measured at block 108 and the pitch angle θₚ of the range sensing element 30. In an exemplary embodiment, the vertical clearance cᵥ is determined using an equation:

$${c}_{v} = {d}_{e} * sin {θ}_{p} \qquad ( 3 )$$

wherein cᵥ is the vertical clearance, dₑ is the Euclidian distance, and θₚ is the pitch angle. After block 118, the method 100 proceeds to block 120.

At block 120, the controller 14 determines whether the first ranging sensor 16a and/or the second ranging sensor 16b has been rotated through the entirety of the pitch angle range. If the first ranging sensor 16a and/or the second ranging sensor 16b has not been rotated through the entirety of the pitch angle range, the method 100 proceeds to block 122. If the first ranging sensor 16a and/or the second ranging sensor 16b has been rotated through the entirety of the pitch angle range, the method 100 proceeds to block 124, as will be discussed in greater detail below.

At block 122, the controller 14 uses the electric motor 32 to rotate the range sensing element 30 to change the pitch angle θₚ of the range sensing element 30. In an exemplary embodiment, the range sensing element 30 is rotated by a predetermined pitch angle step size (e.g., five degrees). After block 122, the method 100 returns to block 108 to measure the Euclidian distance dₑ. In other words, the method 100 repeatedly measures the Euclidian distance dₑ, determines the vertical clearance cᵥ, and rotates the range sensing element to determine a plurality of vertical clearances cᵥ at a plurality of pitch angles θₚ, allowing for complete characterization of the location of the first object 28a and/or the second object 28b relative to the vehicle 12.

At block 124, the controller 14 determines a maximum available vertical clearance. In an exemplary embodiment, the maximum available vertical clearance is determined using an equation:

$${v}_{avail , max} = min ( {c}_{v , 1} , {c}_{v , 2} , … , {c}_{v , n} ) + min ( H 1 , H 2 , H 3 , H 4 ) \qquad ( 4 )$$

wherein v_{avail,max} is the maximum available vertical clearance and min (c_{v,1}, c_{v,2}, . . . , c_{v,n}) is a minimum value of the plurality of vertical clearances determined at block 118. After block 124, the method 100 proceeds to block 116.

At block 116, the controller 14 compares the maximum available vertical clearance determined at block 124 to the minimum required vertical clearance determined at block 110. If the maximum available vertical clearance is less than or equal to the minimum required vertical clearance, the method 100 proceeds to block 126. If the maximum available vertical clearance is greater than the minimum required vertical clearance, the method 100 proceeds to enter a standby state at block 128.

At block 126, the controller 14 uses the display 22 to provide a warning notification to the occupant of the vehicle 12. In an exemplary embodiment, the warning notification includes a visual light notification, graphic notification, text notification, and/or the like provided to the occupant by the display 22. In another exemplary embodiment, the warning notification further includes additional feedback to the occupant, including, for example, haptic feedback, audible feedback, and/or the like. In another exemplary embodiment, the controller 14 further uses an advanced driver assistance system (ADAS) to prevent collision of the vehicle 12 with the first object 28a and/or the second object 28b. In another exemplary embodiment, the controller 14 uses an automated driving system of the vehicle 12 to prevent collision of the vehicle 12 with the first object 28a and/or the second object 28b. After block 126, the method 100 proceeds to enter the standby state at block 128.

The system 10 and method 100 of the present disclosure offer several advantages. Using the first ranging sensor 16a and the second ranging sensor 16b, the system 10 may determine clearance height for objects in front of and behind the vehicle 12, allowing opportunity to mitigate collision. The use of the electric motor 32 to adjust the pitch angle of the range sensing elements 30 allows for comprehensive scanning of the environment, thus allowing accurate determination of clearance height when overhead environment geometry is complex. Using the plurality of vertical height sensors 18, the system 10 may determine the height of the vehicle 12, accounting for variations in height due to, for example, cargo loading, suspension adjustment, tire size, tire pressure, and/or the like. Using the first telescopic break-beam sensor 20a and the second telescopic break-beam sensor 20b, the system 10 may determine the height of roof-mounted accessories 40 affixed to the vehicle 12 and/or other cargo carried by the vehicle 12.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for determining vertical clearance for a vehicle, the system comprising:
a first ranging sensor operable to measure a distance relative to an object surrounding the vehicle;
a display operable to provide information to an occupant of the vehicle; and
a controller in electrical communication with the first ranging sensor and the display, wherein the controller is programmed to:
determine a minimum required vertical clearance based at least in part on a height of the vehicle;
determine a maximum available vertical clearance using the first ranging sensor; and
provide a warning to the occupant of the vehicle using the display in response to determining that the maximum available vertical clearance is less than or equal to the minimum required vertical clearance.

2. The system of claim 1, wherein the display is further configured to receive input from the occupant of the vehicle, and wherein to determine the minimum required vertical clearance based at least in part on the height of the vehicle, the controller is further programmed to:
receive the height of the vehicle from the occupant of the vehicle using the display; and
determine the minimum required vertical clearance based at least in part on the height of the vehicle.

3. The system of claim 1, further comprising at least one vertical height sensor in electrical communication with the controller, and wherein to determine the minimum required vertical clearance based at least in part on the height of the vehicle, the controller is further programmed to:
perform at least one vertical height measurement using the at least one vertical height sensor, wherein the at least one vertical height measurement is a distance between a roof of the vehicle and a ground surface; and
determine the minimum required vertical clearance based at least in part on the at least one vertical height measurement.

4. The system of claim 3, wherein the at least one vertical height sensor further comprises a first vertical height sensor, a second vertical height sensor, a third vertical height sensor, and a fourth vertical height sensor, and wherein to determine the minimum required vertical clearance, the controller is further programmed to:
perform a first vertical height measurement using the first vertical height sensor, wherein the first vertical height measurement is a distance between a first corner of the roof of the vehicle and the ground surface;
perform a second vertical height measurement using the second vertical height sensor, wherein the second vertical height measurement is a distance between a second corner of the roof of the vehicle and the ground surface;
perform a third vertical height measurement using the third vertical height sensor, wherein the third vertical height measurement is a distance between a third corner of the roof of the vehicle and the ground surface;
perform a fourth vertical height measurement using the fourth vertical height sensor, wherein the fourth vertical height measurement is a distance between a fourth corner of the roof of the vehicle and the ground surface; and
determine the minimum required vertical clearance based at least in part on the first vertical height measurement, the second vertical height measurement, the third vertical height measurement, and the fourth vertical height measurement.

5. The system of claim 4, wherein the first ranging sensor further comprises a range sensing element and an electric motor operable to rotate the range sensing element along a pitch axis, and wherein to determine the maximum available vertical clearance using the first ranging sensor, the controller is further programmed to:
measure a Euclidian distance between the first ranging sensor and the object surrounding the vehicle using the range sensing element;
determine a vertical clearance based at least in part on the Euclidian distance and a pitch angle of the range sensing element relative to the roof of the vehicle;
rotate the range sensing element using the electric motor to change the pitch angle of the range sensing element;
repeatedly measure the Euclidian distance, determine the vertical clearance, and rotate the range sensing element to determine a plurality of vertical clearances; and
determine the maximum available vertical clearance to be a sum of a minimum value of the plurality of vertical clearances and a minimum value of the first vertical height measurement, the second vertical height measurement, the third vertical height measurement, and the fourth vertical height measurement.

6. The system of claim 5, wherein the first ranging sensor is further configured to measure a distance relative to an object in front of the vehicle, wherein the system further includes a second ranging sensor in electrical communication with the controller, and wherein the second ranging sensor is configured to measure a distance relative to an object behind the vehicle.

7. The system of claim 5, wherein to determine the vertical clearance, the controller is further programmed to:
determine the vertical clearance using an equation:
cᵥ=dₑ*sin θₚ
wherein cᵥ is the vertical clearance, dₑ is the Euclidian distance, and θₚ is the pitch angle.

8. The system of claim 4, wherein to determine the minimum required vertical clearance, the controller is further programmed to:
determine the minimum required vertical clearance to be equal to a maximum value of the first vertical height measurement, the second vertical height measurement, the third vertical height measurement, and the fourth vertical height measurement.

9. The system of claim 4, wherein to determine the minimum required vertical clearance, the controller is further programmed to:
determine a height of a roof-mounted accessory affixed to the roof of the vehicle; and
determine the minimum required vertical clearance to be equal to a sum of the height of the roof-mounted accessory and a maximum value of the first vertical height measurement, the second vertical height measurement, the third vertical height measurement, and the fourth vertical height measurement.

10. The system of claim 9, further comprising a telescopic break-beam sensor system affixed to the roof of the vehicle including a first telescopic break-beam sensor and a second telescopic break-beam sensor in electrical communication with the controller, wherein the telescopic break-beam sensor system is operable to detect an object occluding a line of sight between the first telescopic break-beam sensor and the second telescopic break-beam sensor, and wherein to determine the height of the roof-mounted accessory, the controller is further programmed to:
extend the first telescopic break-beam sensor and the second telescopic break-beam sensor until the line of sight between the first telescopic break-beam sensor and the second telescopic break-beam sensor is not occluded;
retract the first telescopic break-beam sensor and the second telescopic break-beam sensor until the line of sight between the first telescopic break-beam sensor and the second telescopic break-beam sensor becomes occluded by the roof-mounted accessory; and
determine the height of the roof-mounted accessory to be equal to a height of the first telescopic break-beam sensor and the second telescopic break-beam sensor after retracting the first telescopic break-beam sensor and the second telescopic break-beam sensor until the line of sight between the first telescopic break-beam sensor and the second telescopic break-beam sensor becomes occluded by the roof-mounted accessory.

11. A method for determining vertical clearance for a vehicle, the method comprising:
determining a minimum required vertical clearance based at least in part on a height of the vehicle;
determining a maximum available vertical clearance using a first ranging sensor; and
providing a warning to an occupant of the vehicle using a display in response to determining that the maximum available vertical clearance is less than or equal to the minimum required vertical clearance.

12. The method of claim 11, wherein determining the minimum required vertical clearance further comprises:
performing at least one vertical height measurement using at least one vertical height sensor, wherein the at least one vertical height measurement is a distance between a roof of the vehicle and a ground surface; and
determining the minimum required vertical clearance based at least in part on the at least one vertical height measurement.

13. The method of claim 12, wherein determining the minimum required vertical clearance further comprises:
performing a first vertical height measurement using a first vertical height sensor, wherein the first vertical height measurement is a distance between a first corner of the roof of the vehicle and the ground surface;
performing a second vertical height measurement using a second vertical height sensor, wherein the second vertical height measurement is a distance between a second corner of the roof of the vehicle and the ground surface;
performing a third vertical height measurement using a third vertical height sensor, wherein the third vertical height measurement is a distance between a third corner of the roof of the vehicle and the ground surface;
performing a fourth vertical height measurement using a fourth vertical height sensor, wherein the fourth vertical height measurement is a distance between a fourth corner of the roof of the vehicle and the ground surface; and
determining the minimum required vertical clearance based at least in part on the first vertical height measurement, the second vertical height measurement, the third vertical height measurement, and the fourth vertical height measurement.

14. The method of claim 13, wherein determining the maximum available vertical clearance using the first ranging sensor further comprises:
measuring a Euclidian distance between the first ranging sensor and an object surrounding the vehicle using a range sensing element of the first ranging sensor;
determining a vertical clearance based at least in part on the Euclidian distance and a pitch angle of the range sensing element relative to the roof of the vehicle;
rotating the range sensing element to change the pitch angle of the range sensing element;
repeatedly measuring the Euclidian distance, determining the vertical clearance, and rotating the range sensing element to determine a plurality of vertical clearances; and
determining the maximum available vertical clearance to be a sum of a minimum value of the plurality of vertical clearances and a minimum value of the first vertical height measurement, the second vertical height measurement, the third vertical height measurement, and the fourth vertical height measurement.

15. The method of claim 13, wherein determining the minimum required vertical clearance further comprises:
determining the minimum required vertical clearance to be equal to a maximum value of the first vertical height measurement, the second vertical height measurement, the third vertical height measurement, and the fourth vertical height measurement.

16. The method of claim 13, wherein determining the minimum required vertical clearance further comprises:
determining a height of a roof-mounted accessory affixed to the roof of the vehicle; and
determining the minimum required vertical clearance to be equal to a sum of the height of the roof-mounted accessory and a maximum value of the first vertical height measurement, the second vertical height measurement, the third vertical height measurement, and the fourth vertical height measurement.

17. The method of claim 16, wherein determining the height of the roof-mounted accessory further comprises:
extending a first telescopic break-beam sensor and a second telescopic break-beam sensor until a line of sight between the first telescopic break-beam sensor and the second telescopic break-beam sensor is not occluded;
retracting the first telescopic break-beam sensor and the second telescopic break-beam sensor until the line of sight between the first telescopic break-beam sensor and the second telescopic break-beam sensor becomes occluded by the roof-mounted accessory; and
determining the height of the roof-mounted accessory to be equal to a height of the first telescopic break-beam sensor and the second telescopic break-beam sensor after retracting the first telescopic break-beam sensor and the second telescopic break-beam sensor until the line of sight between the first telescopic break-beam sensor and the second telescopic break-beam sensor becomes occluded by the roof-mounted accessory.

18. A system for determining vertical clearance for a vehicle, the system comprising:
a first ranging sensor operable to measure a distance relative to an object in front of the vehicle, wherein the first ranging sensor includes a range sensing element and an electric motor operable to rotate the range sensing element along a pitch axis;
at least one vertical height sensor;
a display operable to provide information to an occupant of the vehicle; and
a controller in electrical communication with the first ranging sensor, the at least one vertical height sensor, and the display, wherein the controller is programmed to:
perform at least one vertical height measurement using the at least one vertical height sensor, wherein the at least one vertical height measurement is a distance between a roof of the vehicle and a ground surface;
determine a minimum required vertical clearance based at least in part on the at least one vertical height measurement;
determine a maximum available vertical clearance using the first ranging sensor; and
provide a warning to the occupant of the vehicle using the display in response to determining that the maximum available vertical clearance is less than or equal to the minimum required vertical clearance.

19. The system of claim 18, wherein to determine the minimum required vertical clearance, the controller is further programmed to:
perform a first vertical height measurement using a first vertical height sensor, wherein the first vertical height measurement is a distance between a first corner of the roof of the vehicle and the ground surface;
perform a second vertical height measurement using a second vertical height sensor, wherein the second vertical height measurement is a distance between a second corner of the roof of the vehicle and the ground surface;
perform a third vertical height measurement using a third vertical height sensor, wherein the third vertical height measurement is a distance between a third corner of the roof of the vehicle and the ground surface;
perform a fourth vertical height measurement using a fourth vertical height sensor, wherein the fourth vertical height measurement is a distance between a fourth corner of the roof of the vehicle and the ground surface; and
determine the minimum required vertical clearance based at least in part on the first vertical height measurement, the second vertical height measurement, the third vertical height measurement, and the fourth vertical height measurement, wherein the minimum required vertical clearance is a maximum value of the first vertical height measurement, the second vertical height measurement, the third vertical height measurement, and the fourth vertical height measurement.

20. The system of claim 19, wherein to determine the maximum available vertical clearance using the first ranging sensor, the controller is further programmed to:
measure a Euclidian distance between the first ranging sensor and the object surrounding the vehicle using the range sensing element;
determine a vertical clearance based at least in part on the Euclidian distance and a pitch angle of the first ranging sensor relative to the roof of the vehicle;
rotate the range sensing element using the electric motor to change the pitch angle of the range sensing element;
repeatedly measure the Euclidian distance, determine the vertical clearance, and rotate the range sensing element to determine a plurality of vertical clearances; and
determine the maximum available vertical clearance to be a sum of a minimum value of the plurality of vertical clearances and a minimum value of the first vertical height measurement, the second vertical height measurement, the third vertical height measurement, and the fourth vertical height measurement.
